(19) United States
(12) Patent Application Publication
(10) Pub. No.: US 2006/0132860 A1
(43) Pub. Date: Jun. 22, 2006

(54) Display apparatus and method of processing image thereof

(75) Inventor: Jung-ho Roh, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/281,375

(22) Filed: Nov. 18, 2005

(30) Foreign Application Priority Data
Dec. 22, 2004 (KR) 10-2004-0110329

(51) Int. Cl. H04N 1/38

(52) U.S. Cl. 358/463

(57) ABSTRACT

A display apparatus receiving an image signal and processing the image signal to be displayable on the basis of a macro-block is provided. The display apparatus includes an image signal receiving part receiving a coded signal including the image signal and converting the coded signal into a transport stream, an image converting part converting the transport stream into the image signal including the macro-block for each frame and outputting the image signal, a block noise detecting part detecting a noise value at a border area between adjacent macro-blocks of the image signal and comparing the noise value with a predetermined standard value, and a control part providing a feedback signal to control the amplification ratio of the image signal on the basis of the detected noise value. Thus the noise value detected from a border area between blocks in every frame forming the image signal is compared with a predetermined standard value so that the image signal having reduced block noise may be processed to display.

### CROSS-REFERENCE TO RELATED APPLICATIONS

This application claims the priority from Korean Patent Application No. 10-2004-0110329, filed on Dec. 22, 2004, in the Korean Intellectual Property Office, the disclosure of which is incorporated herein in its entirety by reference.

### BACKGROUND OF THE INVENTION

1. Field of the Invention

The present invention relates to a display apparatus and a controlling method thereof, and more particularly, to a display apparatus processing a received image signal to reduce a block noise and a method of processing an image thereof.

2. Description of the Related Art

According to image processing methods for coding/decoding an image signal into a digital format including MPEG, a digitally coded image signal which is transmitted by a transmitting side is processed so that a receiving side can decode the image signal to display an image. An audio signal as well as the image signal may be multiplexed and coded to transmit, and the transmitted signals may also be demultiplexed and decoded in the display apparatus at the receiving side.

According to various kinds of international standards for coding the image signal including MPEG, the image signal is processed on the basis of a block. For example, according to the MPEG standard, the image signal is processed on the basis of the block which has a predetermined number of pixels, that is a macro-block, to achieve a high compression ratio. In the display apparatus receiving the image signal which has been compressed by the block, coded and transmitted, the image signal may be transformed into a predetermined format to be displayed at a display part through processes of channel decoding, demultiplexing, image decoding, audio decoding, error correction, etc.

However, a deterioration in a picture quality may occur if the image signal coded by the block is restored through the above-mentioned processes in the display apparatus at the receiving side. Especially, if the image signal processed by the block is displayed in the format of a frame image signal which may be recognized by a user, a noise occurs in a border part between blocks when the image signal restored by the block is displayed at the display apparatus. Accordingly, the user may recognize the border of the block due to the noise, which is so called ‘blocking’. Thus, it is required to take measures for preventing occurrences of blocking.

### SUMMARY OF THE INVENTION

Accordingly, it is an aspect of the present invention to provide a display apparatus and a method of processing an image thereof, where a noise value detected from a border area between blocks in every frame forming the image signal is compared with a predetermined standard value so that the image signal having reduced block noise may be processed for display.

Additional aspects of the present invention will be set forth in part in the description which follows and, in part, will be obvious from the description, or may be learned by practice of the present invention.

The foregoing and other aspects of the present invention are also achieved by providing a display apparatus receiving an image signal and processing the image signal to be displayable on the basis of a macro-block, comprising: an image signal receiving part receiving a coded signal comprising the image signal and converting the coded signal into a transport stream and providing the transport stream; an image converting part converting the transport stream provided by the image signal receiving part into the image signal comprising the macro-block for each frame and outputting the image signal; a block noise detecting part detecting a noise value at a border area between adjacent macro-blocks of the image signal and comparing the noise value with a predetermined standard value; and a control part providing a feedback signal to control the amplification ratio of the image signal on the basis of the noise value detected by the block noise detecting part.

According to an aspect of the present invention, the control part provides the feedback signal to the image signal receiving part or the image converting part to control the amplification ratio of the image signal.

According to an aspect of the present invention, the block noise detecting part comprises a block noise summing part calculating a sum value of differences in the brightness of pixels at the border area between the adjacent macro-blocks in each frame of the image signal as the noise value.

According to an aspect of the present invention, the block noise summing part calculates the sum value of differences in the brightness of pixels at the border area of all macro-blocks in each frame of the image signal as the noise value.

According to an aspect of the present invention, the block noise summing part calculates the sum value of the differences in the brightness of pixels at the border area of the macro-blocks located at a predetermined region in each frame of the image signal as the noise value.

According to an aspect of the present invention, the block noise detecting part comprises a noise block counting part counting the number of the noise block whose sum value of the differences in the brightness of pixels at the border area between the adjacent macro-blocks is higher than the standard value.

The foregoing and other aspects of the present invention are also achieved by providing a method of processing an image of a display apparatus which receives an image signal and processes the image signal to be displayable on the basis of a macro-block, comprising: receiving a coded signal comprising the image signal and converting the coded signal into a transport stream; converting the transport stream into the image signal comprising the macro-block for each frame; detecting a noise value at a border area between the adjacent macro-blocks of the converted image signal and comparing the noise value with a predetermined standard value; and controlling an amplification ratio of the image signal on the basis of the detected noise value.

According to an aspect of the present invention, the noise value is calculated on the basis of a sum value of differences in the brightness of pixels at the border area between the adjacent macro-blocks in each frame of the image signal.

According to an aspect of the present invention, the noise value is calculated on the basis of the sum value of differences in the brightness of pixels at the border area of all macro-blocks in each frame of the image signal.

According to an aspect of the present invention, the noise value is calculated on the basis of the sum value of the differences in the brightness of pixels at the border area of the macro-blocks located at a predetermined region in each frame of the image signal.

According to an aspect of the present invention, the noise value is calculated by counting the number of the noise block whose sum value of the differences in the brightness of pixels at the border area between the adjacent macro-blocks in each frame of the image signal is higher than the standard value.

### BRIEF DESCRIPTION OF THE DRAWINGS

The above and other aspects of the present invention will become apparent and more readily appreciated from the following description of exemplary embodiments, taken in conjunction with the accompanying drawings of which:

FIG. 1 is a schematic block diagram of a display apparatus according to an exemplary embodiment of the present invention;

FIGS. 2A and 2B are mimetic diagrams for detecting a block noise in the display apparatus according to an exemplary embodiment of the present invention;

FIGS. 3A-3C are mimetic diagrams for detecting a block noise in the display apparatus according to another exemplary embodiment of the present invention; and

FIG. 4 is a control flow chart according to a method of processing image of the display apparatus according to another exemplary embodiment of the present invention.

### DETAILED DESCRIPTION OF THE PREFERRED EMBODIMENT

Reference will now be made in detail to exemplary embodiments of the present invention, examples of which are illustrated in the accompanying drawings, wherein like reference numerals refer to like elements throughout.

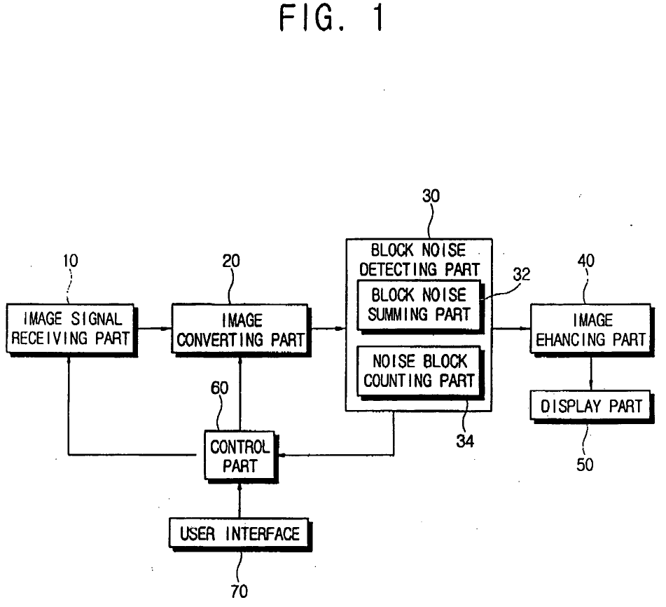

FIG. 1 is a simplified block diagram of a display apparatus according to an exemplary embodiment of the present invention. The display apparatus according to the exemplary embodiment of the present invention may process a received image signal to be displayable on the basis of a macro-block. As shown in FIG. 1, the display apparatus according to the exemplary embodiment of the present invention comprises an image signal receiving part 10, an image converting part 20, a block noise detecting part 30 and a control part 60. The image signal receiving part 10 receives a coded signal having an image signal, converts the coded signal into a transport stream (TS) and provides the transport stream. The image converting part 20 converts the transport stream provided by the image signal receiving part 10 into a block image signal comprising a macro-block for each frame and outputs the block image signal. The block noise detecting part 30 detects a noise value corresponding to a border area between adjacent macro-blocks of the image signal and compares the noise value with a predetermined standard value. The control part 60 provides a feedback signal to control an amplification ratio of the image signal on the basis of the noise value detected by the block noise detecting part 30. The control part 60 may control every element of the display the amplification ratio of the image signal.

The image signal receiving part 10 converts the coded signal received from various kinds of signal sources into the transport stream and provides the transport stream to the image converting part 20. The image signal receiving part 10 may comprise a channel decoder to convert a transmitted coded broadcast signal through a tuner and the like into the transport stream and provide the transport stream to the image converting part 20.

The image converting part 20 may comprise a video decoder to convert the image signal separated from the transport stream. The transport stream which has been converted through the image signal receiving part 10 may comprise an audio signal and a program information signal, etc. as well as the image signal. Accordingly, a transport demultiplexing part may be provided between the image converting part 20 and the image signal receiving part 10 to demultiplex the transport stream to respectively separate the image signal, the audio signal and the program information signal from the transport stream. Also, an audio decoder may further be provided to convert the audio signal which has been separated from the transport stream.

The block noise detecting part 30 may comprise a block noise summing part 32 to calculate a block noise value for the macro-block forming the frame of the image signal. The block noise detecting part 30 may further comprise a noise block counting part 34 to count the number of the macro-blocks each of which has the noise value larger than the predetermined standard value. The block noise value and the number of the noise blocks detected and calculated by the block noise detecting part 30 are provided to the control part 60. Accordingly, the control part 60 provides a controlled feedback signal to the image signal receiving part 10 or the image converting part 20 on the basis of the detected value provided by the block noise detecting part 30. Thus, the amplification ratio of the transport stream or the block image signal which is converted according to the image signal outputted from the image signal receiving part 10 or the image converting part 20 may be controlled.

The block noise summing part 32 calculates a sum value as the noise value for a difference in the brightness of the pixels in the border area of the adjacent macro-blocks and provides the quantified noise value to the control part 60 to reflect on the signal amplification ratio which is provided as the feedback signal.

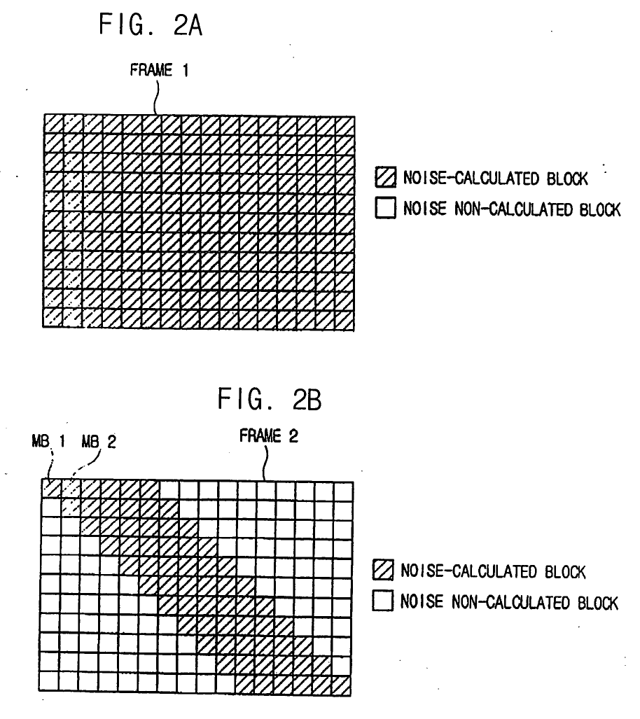

The block noise summing part 32 may calculate the sum value as the noise value for the difference in the brightness of the pixels in the border area for all the macro-blocks in each frame of the image signal. FIG. 2A shows an example where the noise value is calculated on the basis of the sum value for the difference in the brightness of the pixels in the border area for all the macro-blocks.

Suppose that one macro-block has 16×16 pixels. As the block noise appears by the macro-block, the noise value should be calculated by summing the difference in the brightness between the leftmost column of pixels of each macro-block and the rightmost column of pixels of the adjacent macro-block. That is, the noise value is calculated by summing the difference in the brightness between every sixteenth pixel along a horizontal axis of the frame and the next pixel along the horizontal axis of the frame. In the border area between macro-blocks for each frame, the noise value may also be calculated for the adjacent leftmost vertical row of pixels and rightmost vertical row of pixels, the adjacent uppermost horizontal row of pixels and lowermost horizontal row of pixels or both of the adjacent leftmost/rightmost vertical rows and the adjacent uppermost/lowermost horizontal rows.

As shown below, Equation (1) is an exemplary equation for calculating the noise value on the basis of the sum value for the difference in the brightness of the adjacent leftmost vertical row of pixels and rightmost vertical row of pixels in each border area of the adjacent macro-blocks for all macro-blocks in one frame.

$${\sum }_{i = 1}^{( H - 16 ) / 16} {\sum }_{j = 1}^{V} [ ( 16 i , j ) - ( 16 i + 1 , j ) ] \qquad ( 1 )$$

(H: number of pixels along horizontal axis, V: number of pixels along vertical axis, (i,j): brightness value of corresponding pixel)

Also, the block noise summing part 32 may calculate the sum value as the noise value for the difference in the brightness of the pixels in the border area of the macro-blocks located at a predetermined region. FIG. 2B shows an example where the noise value is calculated on the basis of the sum value for the difference in the brightness of the pixels in the border area for the macro-blocks located at some region arrayed in a diagonal direction of the frame. In this case, the time required for calculating the block noise value is reduced in comparison with the time required in FIG. 2(a) where the block noise value is calculated for the whole frame.

As shown below, Equation (2) is an exemplary equation for calculating the block noise value for the diagonal region arrayed in a diagonal direction of the frame in FIG. 2B.

$${\sum }_{i = 1}^{( H - 16 ) / 16} {\sum }_{i = 16 ( k + 1 )}^{V + 16 k} {\sum }_{j = 1}^{V} [ \{ ( \frac{i}{16} \times 16 , i \} - \{ ( \frac{i}{16} ) \times 16 + 1 , j \} ] \qquad ( 2 )$$

(H: number of pixels along horizontal axis, V: number of pixels along vertical axis, (i,j): brightness value of corresponding pixel)

If the difference in the brightness of the border area between a macro-block 1 (MB1) and a macro-block 2 (MB2) (referring to FIG. 2B) is calculated for some pixels using the table shown below, the noise value (SUM) may be represented as (H16-H17), where H16 refers to the sum of the brightnesses of the pixels comprising the rightmost vertical row of MB1 and H17 refers to the sum of the brightnesses of the pixels comprising the leftmost vertical row of MB2.

TABLE

Horizontal pixel

| Vertical pixel | H15 | H16 | H17 | H18 |
|---|---|---|---|---|
| V1 | (15, 1) | [16, 1] | [17, 1] | (18, 1) |
| V2 | (15, 2) | [16, 2] | [17, 2] | (18, 2) |
| V3 | (15, 3) | [16, 3] | [17, 3] | (18, 3) |
| V4 | (15, 4) | [16, 4] | [17, 4] | (18, 4) |

(where, the value in ( ) and [] refers to the brightness of the corresponding pixel)

Also, the noise block counting part 34 counts the number of the noise blocks whose sum value from the difference in the brightnesses between the pixels in the border area of the adjacent macro-blocks is larger than the predetermined standard value.

Generally, if the macro-block of a square type which has been estimated to be the noise block is decoded abnormally, two possible cases may happen. Firstly, a particular block may be dumped with a single color. This is because a restoration with the consideration of the circumferential value is imperfectly performed by imperfect motion compensation. Secondly, some blocks may be filled with wrong image data because motion vectors may have errors due to damaged parts of the converted data signal during decoding. In both cases, the brightness values at the outermost edge pixels of one macro-block and the adjacent macro-block are different with each other.

Thus, the noise block counting part 34 adds the differences in the brightness values between the row pixels and between the column pixels at the border area of the adjacent macro-blocks. Thus, if the added difference, i.e. the sum value is larger than the predetermined standard value, the noise block counting part 34 decides the macro-block as the noise block and adds to a count number.

The calculation of the differences in the brightness values at the border area of the adjacent macro-blocks may be performed by the equation (1) or the equation (2) for all the macro-blocks in the whole frame or for the macro-blocks in the predetermined region.

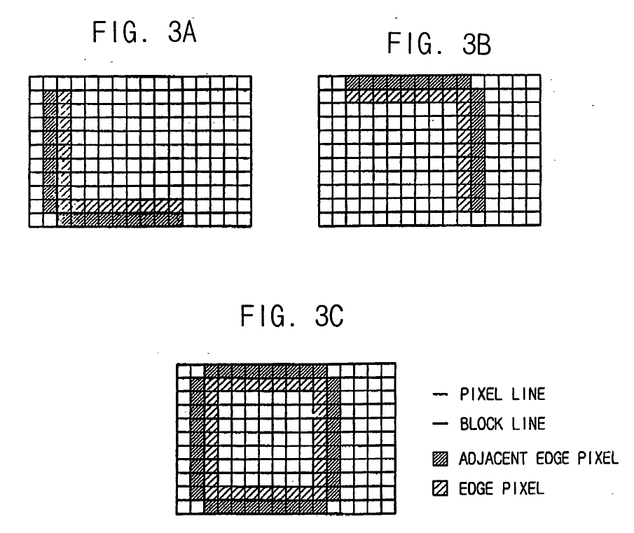

For example, as shown in FIGS. 3A-3C, the calculation of the differences in the brightness values may be conducted for edge pixel columns and edge pixel rows. In FIG. 3A, the calculation is conducted for a leftmost edge pixel column and a lowermost edge pixel row of each macro-block with respect to an adjacent edge pixel column and an adjacent edge pixel row of adjacent macro-blocks. Also, in FIG. 3B, the calculation is conducted for a rightmost edge pixel column and an uppermost edge pixel row of each macro-block with respect to an adjacent edge pixel column and an adjacent edge pixel row of adjacent macro-blocks. Also, in FIG. 3C, the calculation is conducted for the respective edge pixel columns and the respective edge pixel columns of each macro-block with respect to each adjacent edge pixel column and each adjacent edge pixel row of adjacent macro-blocks.

When the noise block counting part 34 counts the number of the noise blocks, an appropriate method or a combination of methods may be selected from the methods shown in FIGS. 3A-3C according to a formation of the noise blocks.

Accordingly, the counted number of the noise blocks is provided to the control part 60. The control part 60 compares the provided number of the noise blocks with the predetermined standard value to control the signal amplification ratio and generates a signal amplification feedback signal in which the block noise is reflected. Thus, the overall noise of the transport stream or the block image signal which correspond to the image signal outputted by the image signal receiving part 10 or the image converting part 20 is reduced by the feedback signal provided by the control part 60. The image signal with the reduced noise may pass through an image enhancing part 40 to improve the picture quality and may be displayed as a frame image having a highest picture quality at a display part 50.

According to the results calculated by the block noise detecting part 30, the control part 60 may maintain the amplification ratio of the image signal to have a predetermined value in consideration of the standard value for the signal amplification. Also, the detection of the block noise may be periodically performed according to a predetermined periodic time. The predetermined periodic time may be set through a user interface 70. Also, the signal amplification ratio may be selectively controlled using a control button provided at the user interface 70 when the image displayed at the display part 50 turns out to have poor color quality.

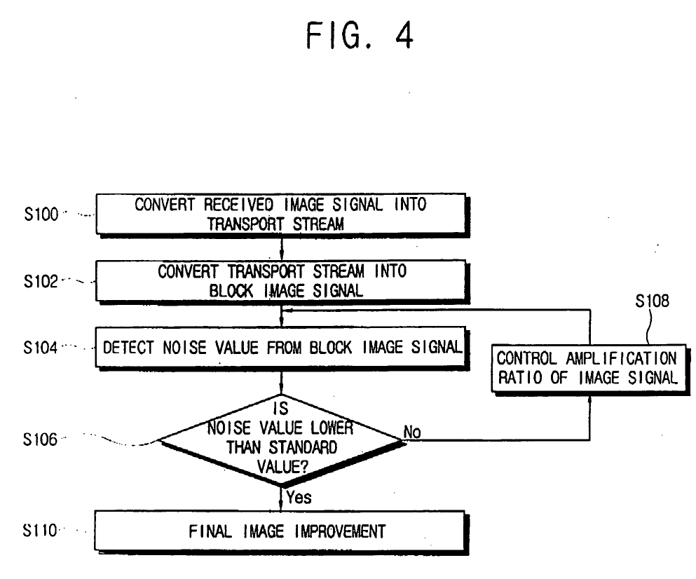

A method of processing the image of the display apparatus according to an exemplary embodiment of the present invention, which is shown as a control flow diagram in FIG. 4, is described as follows.

The image signal receiving part 10 receives the coded image signal and converts it into the transport stream at operation S100. As described above, the coded image signal may include the audio signal, etc. as well as the image signal. The image signal which has been converted into the transport stream is provided to the image converting part 20 to be converted into the block image signal comprising the macro-block in each frame at operation 102.

Accordingly, the block noise detecting part 30 detects the noise in the macro-blocks forming the frame by the converted block image signal at operation S104. The detection of the noise in the macro-block is performed by the block noise summing part 32 and the noise block counting part 34 to get the sum value by summing the differences in the brightness at the border area between the adjacent macro-blocks or to get the number of the noise blocks.

When the noise value of the macro-blocks forming the frame is detected by the block noise detecting part 30, the control part 60 controlling the signal amplification ratio determines whether the detected noise value is lower than the predetermined standard value at operation S106. If the detected noise value is determined to be lower than the predetermined standard value, the block image signal undergoes an image processing by the image enhancing part 40 to be finally treated to have enhanced color quality. If the detected noise value is determined to be higher than the predetermined standard value, the control part 60 controls the signal amplification ratio of the image signal to reduce the noise at operation S108. The feedback signal by which the control part 60 controls the signal amplification ratio may be provided to the image signal receiving part 10 or the image converting part 20.

Thus, the detecting process may be repeatedly performed to the image signal according to the controlled signal amplification ratio by the block noise detecting part 30.

Although exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus receiving an image signal and processing the image signal to be displayable on the basis of a macro-block, the apparatus comprising:
an image signal receiving part which receives a coded signal comprising the image signal and converts the coded signal into a transport stream and provides the transport stream;
an image converting part which converts the transport stream provided by the image signal receiving part into the image signal comprising the macro-block for each frame and outputs the image signal;
a block noise detecting part which detects a noise value at a border area between adjacent macro-blocks of the image signal and compares the noise value with a predetermined standard value; and
a control part which provides a feedback signal to control an amplification ratio of the image signal on the basis of the noise value detected by the block noise detecting part.

2. The display apparatus according to claim 1, wherein the control part provides the feedback signal to the image signal receiving part or the image converting part to control the amplification ratio of the image signal.

3. The display apparatus according to claim 1, wherein the block noise detecting part comprises a block noise summing part which calculates a sum value of differences in the brightness of pixels at the border area between the adjacent macro-blocks in each frame of the image signal as the noise value.

4. The display apparatus according to claim 3, wherein the block noise summing part calculates the sum value of differences in the brightness of pixels at the border area of all macro-blocks in each frame of the image signal as the noise value.

5. The display apparatus according to claim 3, wherein the block noise summing part calculates the sum value of the differences in the brightness of pixels at the border area of the macro-blocks located at a predetermined region in each frame of the image signal as the noise value.

6. The display apparatus according to claim 1, wherein the block noise detecting part comprises a noise block counting part which counts a number of noise blocks whose sum value of the differences in the brightness of pixels at the border area between the adjacent macro-blocks is higher than the predetermined standard value.

7. The display apparatus according to claim 4, wherein the block noise detecting part comprises a noise block counting part which counts a number of noise blocks whose sum value of the differences in the brightness of pixels at the border area between the adjacent macro-blocks is higher than the predetermined standard value.

8. The display apparatus according to claim 5, wherein the block noise detecting part comprises a noise block counting part which counts a number of noise blocks whose sum value of the differences in the brightness of pixels at the border area between the adjacent macro-blocks is higher than the predetermined standard value.

9. A method of processing an image of a display apparatus which receives an image signal and processes the image signal to be displayable on the basis of a macro-block, the method comprising:
receiving a coded signal comprising the image signal and converting the coded signal into a transport stream;
converting the transport stream into the image signal comprising the macro-block for each frame;
detecting a noise value at a border area between. adjacent macro-blocks of the converted image signal and comparing the noise value with a predetermined standard value; and
controlling an amplification ratio of the image signal on the basis of the detected noise value.

10. The method of processing the image of the display apparatus according to claim 9, wherein the noise value is calculated on the basis of a sum value of differences in the brightness of pixels at the border area between the adjacent macro-blocks in each frame of the image signal.

11. The method of processing the image of the display apparatus according to claim 10, wherein the noise value is calculated on the basis of the sum value of differences in the brightness of pixels at the border area of all macro-blocks in each frame of the image signal.

12. The method of processing the image of the display apparatus according to claim 10, wherein the noise value is calculated on the basis of the sum value of the differences in the brightness of pixels at the border area of the macro-blocks located at a predetermined region in each frame of the image signal.

13. The method of processing the image of the display apparatus according to claim 9, wherein the noise value is calculated by counting a number of noise blocks whose sum value of the differences in the brightness of pixels at the border area between the adjacent macro-blocks in each frame of the image signal is higher than the predetermined standard value.

14. The method of processing the image of the display apparatus according to claim 11, wherein the noise value is calculated by counting a number of noise blocks whose sum value of the differences in the brightness of pixels at the border area between the adjacent macro-blocks in each frame of the image signal is higher than the predetermined standard value.

15. The method of processing the image of the display apparatus according to claim 12, wherein the noise value is calculated by counting a number of noise blocks whose sum value of the differences in the brightness of pixels at the border area between the adjacent macro-blocks in each frame of the image signal is higher than the predetermined standard value.
